(19) United States
(12) Patent Application Publication
(10) Pub. No.: US 2014/0032304 A1
(43) Pub. Date: Jan. 30, 2014

(54) DETERMINING A CORRELATION BETWEEN PRESENTATION OF A CONTENT ITEM AND A TRANSACTION BY A USER AT A POINT OF SALE TERMINAL

(71) Applicant: James Kent, London (GB)

(72) Inventor: James Kent, London (GB)

(73) Assignee: Google Inc.

(21) Appl. No.: 13/560,349

(22) Filed: Jul. 27, 2012

(51) Int. Cl. G06Q 30/02

(52) U.S. Cl. 705/14.43; 705/14.41

(57) ABSTRACT

Methods and systems for determining a correlation between an online campaign and offline activity may include generating a content item and content identifier data identifying the content item, transmitting the content item and content identifier data over a network to a client computer, wherein the content item or content identifier data is configured to cause the client computer to display the content item on a resource and to emit a first signal based on the content identifier data, receiving an indication that the content identifier data was received at the time of a transaction by a user at a point of sale terminal, and determining a correlation between presentation of the content item and the transaction based on the generated content identifier data and the received content identifier data.

### BACKGROUND

The present disclosure relates generally to systems and methods for linking an online campaign with offline store purchases and more particularly, to determining a correlation between presentation of a content item and a transaction by a user at point of sale terminal.

### SUMMARY

In one implementation, in general, a computer-implemented method is disclosed herein that may include attempting, by a mobile computing device, to detect a first signal from a nearby computing device, the first signal comprising content identifier data which identifies a content item from an online campaign displayed on the computing device, the first signal comprising at least one of a visual signal, a sound signal, or a wireless data signal. The method may also include, upon detection of the first signal, retrieving the content identifier data from the first signal and storing the content identifier data in a memory of the mobile computing device. The method may further include providing, by the mobile computing device, a second signal comprising the content identifier data to a point of sale terminal at which a product related to the content item is purchased.

In another implementation, in general, a computer-implemented method is disclosed herein that may include generating, at a server computer, a content item and content identifier data identifying the content item. The method may also include transmitting the content item and content identifier data over a network to a client computer, wherein the content item or content identifier data is configured to cause the client computer to display the content item on a resource and to emit a first signal based on the content identifier data in the form of at least one of a visual signal, a sound signal, or a wireless data signal. The method may further include receiving, at the server computer, an indication that the content identifier data was received at the time of a transaction by a user at a point of sale terminal. The method may yet further include determining a correlation between presentation of the content item and the transaction based on the generated content identifier data and the received content identifier data. The method may also include generating output data indicative of the correlation.

In yet another implementation, in general, a computer-readable storage medium having instructions therein, the instructions being executable by a processor to cause the processor to perform operations that may include generating, at a server computer, a content item and content identifier data identifying the content item. The operations may also include transmitting the content item and content identifier data over a network to a client computer, wherein the content item or content identifier data is configured to cause the client computer to display the content item on a resource and to emit a first signal based on the content identifier data in the form of at least one of a visual signal, a sound signal, or a wireless data signal. The operations may further include receiving, at the server computer, an indication that the content identifier data was received at the time of a transaction by a user at a point of sale terminal. The operations may also include determining a correlation between presentation of the content item and the transaction based on the generated content identifier data and the received content identifier data. The operations may include generating output data indicative of the correlation.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is an example of a block diagram of a computer system in accordance with a described implementation;

FIG. 2 is an illustration of an example system for serving a content item in accordance with a described implementation;

FIG. 3 is an illustration of an example system in accordance with a described implementation;

FIG. 4 is an example of a flow diagram of online activity, in accordance with a described implementation;

FIG. 5 is an example of a flow diagram of an algorithm operable on a mobile device that periodically updates, in accordance with a described implementation;

FIG. 6 is an example of a flow diagram of offline activity, in accordance with a described implementation;

FIG. 7 is an example of a flow chart of a method for providing a signal to a point of sale terminal in accordance with a described implementation; and

FIG. 8 is an example of a flow chart of a method for determining a correlation between presentation of a content item and a transaction by a user at a point of sale terminal in accordance with a described implementation.

Like reference numbers and designations in the various drawings indicate like elements.

### DETAILED DESCRIPTION

A webpage such as a search results page may include content item slots in which content items (e.g., advertisements, articles, etc.) may be presented. These content item slots may be defined in the webpage or defined for presentation with a webpage, for example, as part of the webpage, or in a pop-up window.

Content item slots may be allocated to third party content providers (e.g., advertisers) through an auction. For example, content providers may provide bids specifying amounts that the content providers are willing to pay for presentation of their content items. In turn, an auction may be performed and the content item slots may be allocated to the providers according to their bids. When one content item slot is being allocated in the auction, the content item slot may be allocated to the content provider that provides the highest bid or a highest auction score (e.g., a score that may be computed as a function of a bid and/or a content item quality measure, where the content item quality measure may comprise data indicating how well the content of the content item matches a user's search for a certain keyword). When multiple content item slots are allocated in a single auction, the content item slots may be allocated to a set of bidders that provide the highest bids or have the highest auction scores.

Content item management accounts may enable content providers to specify keywords and corresponding bids that are used to control allocation of their content items. The content provider may track the performance of content items that are provided using the keywords and corresponding bids. For example, a content provider may access the content item management account and view performance measures corresponding to the content provider's content items that were distributed using each keyword. In turn, the content provider may adjust settings that control the allocation of content items and compare the performance measures for the content items that are allocated using the new settings.

An online campaign may be used to further manage the serving of a content item. The campaign may specify the budget for the content items, when, where, and under what conditions particular content items may be served, etc. The online campaign may include, for example, a unique email address, a password, billing information, etc. The online campaign generally refers to campaign activity, such as selecting specific content items to be served to users in certain geographical locations, selecting specific content items to serve based on different product lines, or selecting specific content items to be served to certain user groups. Campaign information may include, for example, one or more budgets for one or more time periods (e.g., a daily budget), geo-targeting information, syndication preference information, start and end dates of the campaign, etc.

The online campaign may be part of Internet marketing (also known as online marketing, web marketing, or e-marketing). The effectiveness of online marketing may be measured by cost per impression (CPI), or cost per thousand impressions (CPM), where an impression may be counted for example whenever a content item server serves a content item onto a user's screen. Some of the impressions lead to users clicking on the ad, and a click-through rate (CTR) may be defined as the number of clicks on the content item divided by the number of impressions.

Content item pricing sometimes may be more accurately determined by cost per action (CPA). The actions may include, for example, users interacting with the content item such as clicking on the content item or a link therein, users' purchase of a product, users referring the content item to other users, etc. Correspondingly, the content item pricing may be measured as cost per click-through (CPC; counted when a content item is clicked), cost per sale (CPS), and cost per lead (CPL). Sometimes an effective CPM (eCPM) may be used to measure the effectiveness of a content item, where actual actions such as clicks may be factored into the calculation.

In some implementations, the content items may be associated with searches, where users may be attracted to the content items through search result pages, and the searches may lead to the users' clicks on the content items. Each campaign may be associated with one or more content item groups. A content item group may include one or more content items that may be associated with different sets of keywords. Content item group information may include, for example, keywords that may be used by a relevancy determination operation to decide whether to show the content item on a search page resulting from the keywords, and cost information such as a maximum bid for the content provider. The different content items within one content item group may have different unique identifiers, and content providers may be allowed to see the different performances of the different content items from the content providers' web access.

Some of the users visiting the webpage may take a desired action beyond simple browsing (impression) of the webpage. The desired actions may include, for example, buying a product from the webpage, joining a membership, opening an account, subscribing to a newsletter, downloading an application, etc. The percentage of such visitors taking the desired actions may be referred to as the conversion rate.

A content item and its associated outcome (e.g., users' purchase of content providers' items or services for sale) may be associated with both online and offline activities. In general, “online” indicates a state of connectivity such as to the Internet, while “offline” indicates a disconnected state. If a user clicks through an ad, then buys a product at the content provider's resource using an online account, these would be considered online actions. It may be relatively straightforward to link this type of online purchases with impressions and with the effectiveness of the content items.

Some activities may occur during a web browsing session during which the content item is viewed (e.g., a click on an ad), while other activities may occur outside of the web browsing session. Examples of offline activities associated with the online campaign may include users making phone calls to a telephone number as advertised or to the content provider directly, users walking into a store to redeem coupons or purchase items as advertised in the online content item, walking to a store, picking up a phone and making a phone call to the store, moving to a different computer such as a mobile phone and taking further action based on viewing the ad. The store and/or the products being purchased may be associated with a manufacturer or a merchant who provided the content item or is associated with the content item. In general, offline activity may refer to activity relating to products or services outside of the web browsing session that generated a content item that may have led the user to the offline activity.

Content providers may be provided with reports that measure various user interactions with the content that may be distributed to the users for the content providers. In some implementations, the reports that may be provided to a particular content provider specify performance measures representing user interactions with content that occur prior to a conversion.

In some implementations, the reports may be provided on an anonymized basis. It is noted that users may opt out of data collection, or, alternatively, a user may be asked to opt-in before data collection begins. The collected data may be anonymized, or individual user identifiers may be anonymized such that actual user information such as names, credit card numbers, and phone numbers may not be derived from the user identifiers. Thus, a user's privacy may be maintained based on the user's decision.

For situations in which the systems discussed here collect personal information about users, or may make use of personal information, the users may be provided with an opportunity to control whether programs or features that may collect personal information (e.g., information about a user's social network, social actions or activities, a user's preferences, or a user's current location), or to control whether and/or how to receive content from the content server that may be more relevant to the user. In addition, certain data may be anonymized in one or more ways before it is stored or used, so that personally identifiable information is removed when generating monetizable parameters (e.g., monetizable demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server.

The user interactions may include any presentation of content to a user and any subsequent affirmative actions (including online actions and offline actions) or non-actions that a user takes in response to presentation of content to the user (e.g., selections of the content following presentation of the content, or no selections of the content following the presentation of the content). Thus, a user interaction may not necessarily require a selection of the content (or any other affirmative action) by the user.

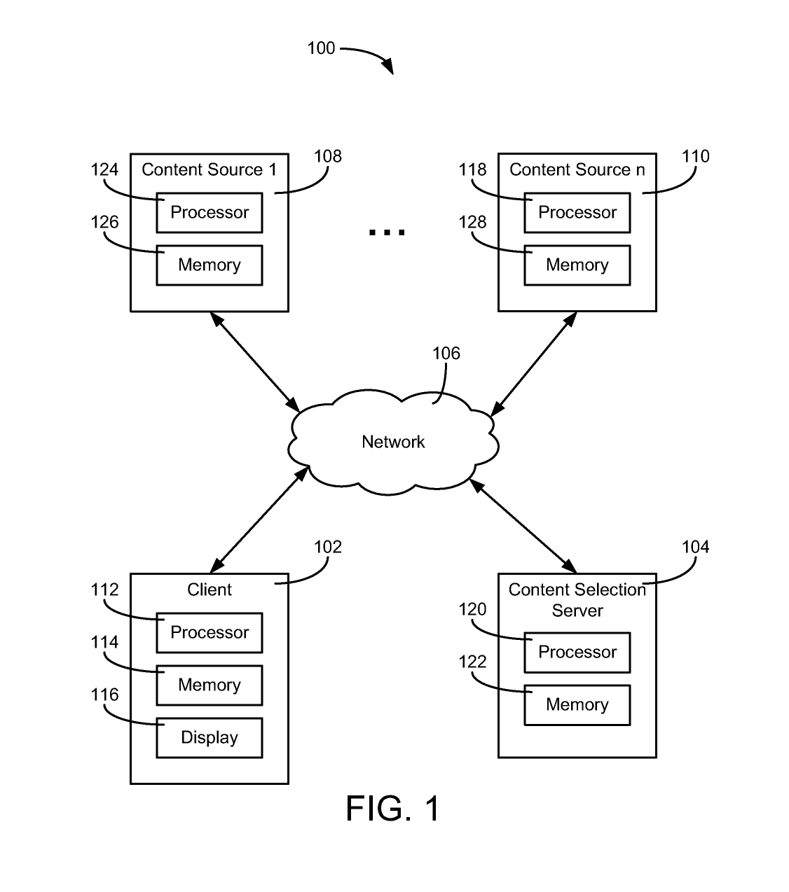

FIG. 1 is a block diagram of a computer system 100 in accordance with a described implementation. System 100 includes client 102, which may communicate with other computing devices via a network 106. For example, client 102 may communicate with one or more content sources ranging from a first content source 108 up to an nth content source 110. Content sources 108, 110 may provide webpages and/or media content (e.g., audio, video, and other forms of digital content) to clients client 102. System 100 may include a content selection server 104, which provides content item data to other computing devices over network 106.

Network 106 may be any form of computer network that relays information between client 102, content selection server 104, and content sources 108, 110. For example, network 106 may include the Internet and/or other types of data networks, such as a local area network (LAN), a wide area network (WAN), a cellular network, satellite network, or other types of data networks. Network 106 may include any number of computing devices (e.g., computer, servers, routers, network switches, etc.) that are configured to receive and/or transmit data within network 106. Network 106 may include any number of hardwired and/or wireless connections. For example, client 102 may communicate wirelessly (e.g., via WiFi, cellular, radio, etc.) with a transceiver that is hardwired (e.g., via a fiber optic cable, a CATS cable, etc.) to other computing devices in network 106.

Client 102 may be any number of different user electronic devices configured to communicate via network 106 (e.g., a laptop computer, a desktop computer, a tablet computer, a smartphone, a digital video recorder, a set-top box for a television, a video game console, etc.). Client 102 is shown to include a processor 112 and a memory 114, e.g., a processing circuit. Memory 114 stores machine instructions that, when executed by processor 112, cause processor 112 to perform one or more of the operations described herein. Processor 112 may include a microprocessor, application-specific integrated circuit (ASIC), field-programmable gate array (FPGA), etc., or combinations thereof. Memory 114 may include, but is not limited to, electronic, optical, magnetic, or any other storage or transmission device capable of providing processor 112 with program instructions. Memory 114 may include a floppy disk, CD-ROM, DVD, magnetic disk, memory chip, ASIC, FPGA, read-only memory (ROM), random-access memory (RAM), electrically-erasable ROM (EEPROM), erasable-programmable ROM (EPROM), flash memory, optical media, or any other suitable memory from which processor 112 may read instructions. The instructions may include code from any suitable computer-programming language such as, but not limited to, C, C++, C#, Java, JavaScript, Perl, Python and Visual Basic.

Client 102 may include one or more user interface devices. In general, a user interface device refers to any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more user interface devices may be internal to a housing of client 102 (e.g., a built-in display, microphone, etc.) or external to the housing of client 102 (e.g., a monitor connected to client 102, a speaker connected to client 102, etc.), according to various implementations. For example, client 102 may include an electronic display 116, which visually displays webpages using webpage data received from content sources 108, 110 and/or from content selection server 104.

Content sources 108, 110 are electronic devices connected to network 106 and provide media content to client 102. For example, content sources 108, 110 may be computer servers (e.g., FTP servers, file sharing servers, web servers, etc.) or other devices that include a processing circuit. Media content may include, but is not limited to, webpage data, a movie, a sound file, pictures, and other forms of data. Similarly, content selection server 104 may include a processing circuit including a processor 120 and a memory 122. In some implementations, content selection server 104 may include several computing devices (e.g., a data center, a network of servers, etc.). In such a case, the various devices of content selection server 104 may comprise a processing circuit (e.g., processor 120 represents the collective processors of the devices and memory 122 represents the collective memories of the devices).

Content selection server 104 may provide digital content items to client 102 via network 106. For example, content source 108 may provide a webpage to client 102, in response to receiving a request for a webpage from client 102. In some implementations, a content item from content selection server 104 may be provided to client 102 indirectly. For example, content source 108 may receive content item data from content selection server 104 and use the content item as part of the webpage data provided to client 102. In other implementations, a content item from content selection server 104 may be provided to client 102 directly. For example, content source 108 may provide webpage data to clients client 102 that includes a command to retrieve a content item from content selection server 104. On receipt of the webpage data, client 102 may retrieve a content item from content selection server 104 based on the command and display the content item when the webpage is rendered on display 116. As described herein, content selection server, recognition server, experiment server or any other server mentioned may be implemented as one server or a collection of servers.

According to various implementations, a user of client 102 may search for, access, etc. various resources (e.g., websites, web pages, articles, images, video, etc.) using a search engine via network 106. The resources may be displayed as a search result from a search engine query containing search terms or keywords. Search engine queries may allow the user to enter a search term or keyword into the search engine to execute a document search. Search engines may be stored in memory 122 of server 104 and may be accessible with client 102. The result of an executed resource search on a search engine may include a display on a search engine document of links to resources. Executed search engine queries may result in the display of online campaign data generated and transmitted from server 104. In some cases, search engines contract with content providers to display online campaign to users of the search engine in response to certain search engine queries.

A user may opt in or out of allowing content selection server 104 or other content source to identify and store information about the user and/or about devices operated by the user. For example, the user may opt in to receiving contents from content selection server 104 that may be more relevant to her. In one implementation, the user may be represented as a randomized device identifier (e.g., a cookie, a device serial number, etc.) that contains no personally-identifiable information about the user. For example, information relating to the user's name, demographics, etc., may not be used by a content selection server unless the user opts in to providing such information. Thus, the user may have control over how information is collected about him or her and used by a content selection server or other content source.

In some implementations, the device identifier is associated with a particular instance of a client application (e.g., running on client device 102). In some implementations, the device identifier is associated with a user (e.g., when the user logs in with a username and password). Some information that may be associated with the user may include events, such as one or more queries, one or more clicks, browser history data (e.g., the URLs visited, the number of URLs viewed, URL visit durations, etc.), etc. Events may also include online campaign metrics, such as impressions, click through rate, etc. for each user. For example, the device identifier may include a time stamp associated with a particular event. Events may also include how many times a user is exposed to a particular ad, a campaign, etc.

Content source 108, 110 may select content to be provided with a webpage based on the device identifier for a user visiting the resource. For example, a user may opt in to receiving relevant contents from a content selection server. Rather than selecting a content to be provided on the resource based on the content of the resource itself or on other factors, content selection server 104 may take into account the device identifier provided as part of the content request. In one example, a user may visit a number of webpages devoted to reviews of golf clubs and later visit a webpage to check stock quotes. Based on the user's visits to the golf-related webpages, the user may be determined to be interested in receiving contents for golf clubs. When the user later visits the webpage to check stock quotes, an online retailer of golf equipment may seek to include a content on the webpage for that particular user, even though the financial webpage is unrelated to golf.

If content is selected based in part on a device identifier for a user that opts in to receiving more relevant content, a content provider may specify that certain content is to be provided to a set of device identifiers. For example, a content provider may identify a set of device identifiers associated with visiting the content provider's resource and making a purchase. Such users may later wish to know if the content provider is running a sale. In some cases, an online campaign network may identify users on behalf of the content provider that may be interested in receiving contents from the content provider. For example, content providers may specify a number of topic categories for their contents and the online campaign network may match users' interests to the categories, to provide relevant contents to the users.

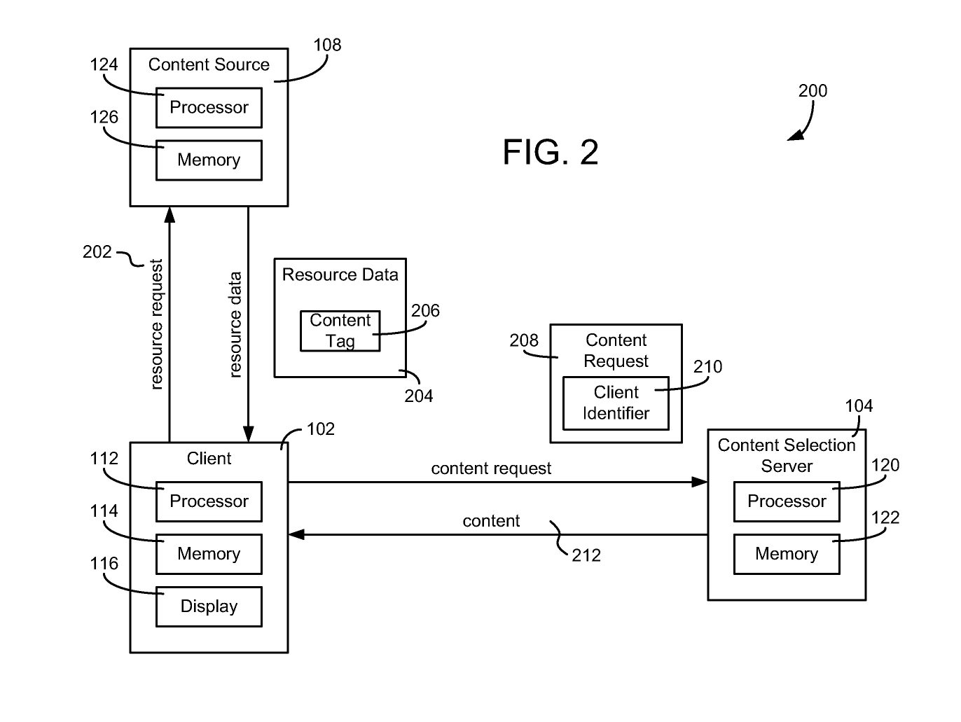

FIG. 2 is an example illustration of content 212 being selected by content selection server 104. As shown, client 102 may send a webpage request 202 to a content source via network 106, such as content source 108. For example, webpage request 202 may be a request that conforms to the hypertext transfer protocol (HTTP), such as the following:

GET /weather.html HTTP/1.1
Host: www.example.org

Such a request may include the name of the file to be retrieved, weather.html, as well as the network location of the file, www.example.org. In some cases, a network location may be an IP address or may be a domain name that resolves to an IP address of content source 108. In some implementations, a client identifier, such as a cookie associated with content source 108, may be included with webpage request 202 to identify client 102 to content source 108.

In response to receiving webpage request 202, content source 108 may return webpage data 204, such as the requested file, “weather.html.” Webpage data 204 may be configured to cause client 102 to display a webpage on electronic display 116 when opened by a web browser application. In some cases, webpage data 204 may include code that causes client 102 to request additional files to be used as part of the displayed webpage. For example, webpage data 204 may include an HTML image tag of the form:
<img src=“Monday_forecast.jpg”>

Such code may cause client 102 to request the image file “Monday_forecast.jpg,” from content source 108.

In some implementations, webpage data 204 may include content tag 206 configured to cause client 102 to retrieve content from content selection server 104. In some cases, content tag 206 may be an HTML image tag that includes the network location of content selection server 104. In other cases, content tag 206 may be implemented using a client-side scripting language, such as JavaScript. For example, content tag 206 may be of the form:

<script type= ‘text/javascript’>
AdNetwork_RetrieveAd(“argument”)
</script>

Where AdNetwork_RetrieveAd is a script function that causes client 102 to send a content request 208 to content selection server 104. In some cases, the argument of the script function may include the network address of content selection server 104, the referring webpage, and/or additional information that may be used by content selection server 104 to select content to be included with the webpage.

Content request 208 may include a client identifier 210, used by content selection server 104 to identify client 102. In various implementations, client identifier 210 may be an HTTP cookie previously set by content selection server 104 on client 102, the IP address of client 102, a unique device serial for client 102, other forms of identification information, or combinations thereof. For example, content selection server 104 may set a cookie that includes a unique string of characters on client 102 when content is first requested by client 102 from content selection server 104. Such a cookie may be included in subsequent content requests sent to content selection server 104 by client 102.

In some implementations, client identifier 210 may be used by content selection server 104 to store history data for client 102, with the permission of the user of client 102. For example, content request 208 may include data relating to which webpage was requested by client 102, when the webpage was requested, and/or other history data. Whenever client 102 visits a webpage participating in the content network, i.e., a webpage that includes content or other content selected by content selection server 104, content selection server 104 may receive and store history data for client 102. In this way, content selection server 104 is able to reconstruct the online history of client 102 regarding webpages in the content network. In some implementations, content selection server 104 may also receive history data for client 102 from entities outside of the content network. For example, a resource that does not use content selected by content selection server 104 may nonetheless provide information about client 102 visiting the resource to content selection server 104, with the user's permission.

In some cases, client identifier 210 may be sent to content selection server 104 when the user of client 102 performs a particular type of online action. For example, webpage data 204 may include a tag that causes client 102 to send client identifier 210 to content selection server 104 when the a displayed content is selected by the user of client 102. Client identifier 210 may also be used to record information after client 102 is redirected to another webpage. For example, client 102 may be redirected to a content provider's resource if the user selects a displayed content. In such a case, client identifier 210 may also be used to record which actions were performed on the content provider's resource. For example, client identifier 210 may also be sent to content selection server 104 as the user of client 102 navigates the content provider's resource. In this way, data regarding whether the user searched for a product, added a product to a shopping cart, completed a purchase on the content provider's resource, etc., may also be recorded by content selection server 104. In some implementations, content selection server 104 may use the data regarding users' online actions to calculate performance metrics for a webpage (e.g., a conversion rate, a click-through rate, etc.).

In response to receiving content request 208, content selection server 104 may select content 212 to be returned to client 102 and displayed on display 116. For example, content selection server 104 may select content 212 based on client identifier 210 and/or on a user identifier associated with client identifier 210. In one implementation, content selection server 104 may determine whether client identifier 210 corresponds to a similar user identifier as that of one or more other user identifiers. For example, content selection server 104 may determine whether a client identifier for client 102 is associated with characteristics that are similar to that of one or more other user identifiers specified by a content provider. Content selection server 104 may analyze history data for the one or more user identifiers specified by the content provider to identify characteristics of the user identifiers. The characteristics may be compared to those of the user identifier associated with client 102 to determine its similarity. In some implementations, content selection server 104 may determine a similarity score to represent how similar the characteristics of the user identifier is to that of the user identifiers specified by the content provider.

Characteristics of a user identifier may include webpages visited by the user identifier, contents selected by the user identifier, and/or contents selected by the user identifier that led to a conversion. In general, a conversion refers to the performance of a certain action. Typically, the action is the purchase of a good or service. For example, a selected content that led to a conversion may be a content that diverted a client device to a resource at which a purchase was made. Other examples of conversions include creating a user profile on a resource, subscribing to receive marketing offers (e.g., by providing a postal or email address, by providing a telephone number, etc.), or downloading software from a resource.

In some implementations, characteristics of user identifiers may be normalized by utilizing a term-frequency inverse document frequency (TF-IDF) count. Webpages visited by a user identifier may be represented by their uniform resource location (URL) or similar addresses. A selected content may be a content embedded into a webpage, a game, a pop-up content, a banner content, or the like.

In some implementations, content selection server 104 may aggregate feature vectors to find a set of characteristics based on a statistical measurement of the aggregated characteristics. For example, the aggregated characteristics may be the number of times a webpage was visited by the set of user identifiers, the number of times a content or group of contents was selected, and/or the number of times a content or group of contents led to a conversion. In various implementations, a statistical measurement of the aggregated characteristics may be the average, median, centroid, or other statistical measure of the aggregated characteristics. In one implementation, the aggregated characteristics having the highest amount of activity may be selected (e.g., the top five most visited webpages, the top ten selected contents, etc.).

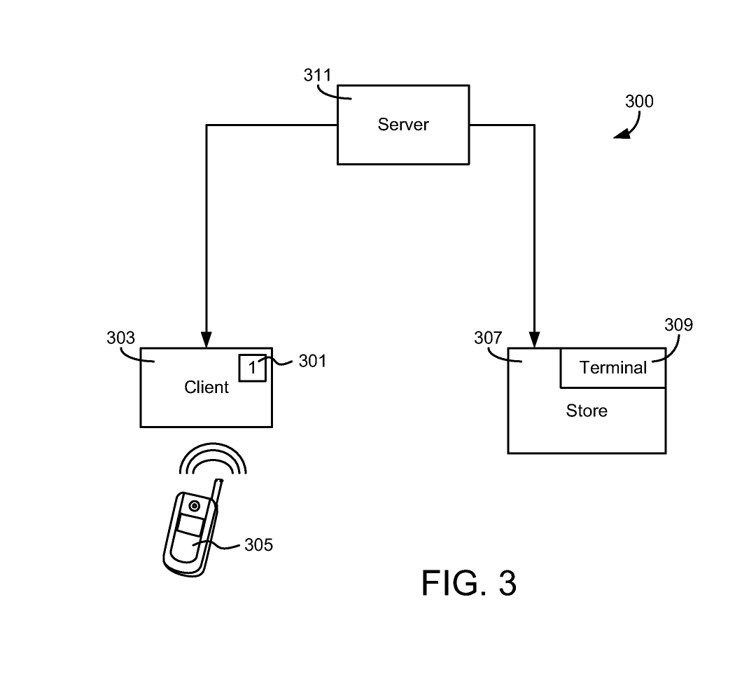

FIG. 3 is an illustration of an example system in accordance with a described implementation. FIG. 3 is an overview of the example system 300. System 300 illustrates a content 301 being served to client device 303. Client device 303 may include a laptop, tablet, desktop, etc. In some implementations, a web browser or other appropriate application may receive content 301. Client device 303 may then emit a signal, such as an audio signal, to mobile computing device 305. The signal may include a code, packet, data, etc. that provides information to mobile computing device 305 related to where to find the code, etc. on the Internet.

Mobile computing device 305 may then be used at store 307 via point of sale terminal 309. For example, mobile computing device 305 may communicate with store 307 using NFC, RFID, wireless, or any other communication standards. For example, mobile computing device 305 may be scanned by terminal 309. Mobile computing device 305 provides the code to terminal 309.

Terminal 309 may provide the code to server 311. Server 311 may be a content selection server or other appropriate server. The code may be stored by server 311. Server 311 may determine that content item 301 provided to client device 303 correlates to the transaction at terminal 309. Therefore, server 311 may store the correlation and provide output data to a third party content provider showing that the online content item 301 triggered the offline activity at store 307.

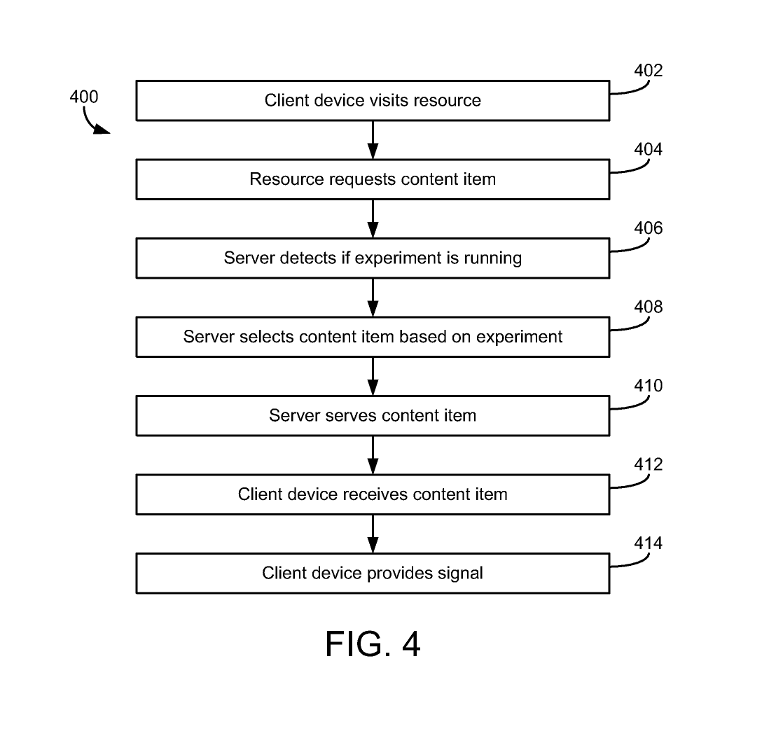

FIG. 4 is an example of a flow diagram of online activity, in accordance with a described implementation. At 402, a user visits a resource of a publisher. At 404, a client device (also referred to as a user device) may request the resource from a content selection server. The client device may include a browser component, an email component, etc. A search engine accessible by the client device via the Internet may allow the client device to search a collection of documents, such as resources. The content selection server may allow the client device to access the resource, documents, etc.

At 406, the content selection server may be used to serve content items to the client device pursuant to the request provided by the client device. Content items may be provided to documents served by the content selection server. In one example, the content selection server may receive the request for documents (e.g., resources, articles, search results, etc.) and retrieve the document in response to the request.

In some implementations, the content selection server may provide a request to another server, such as a content item server. The content item request may include the number of content items desired. In some implementations, the content item request may also include the request for a document, which may include the document itself, a category related to the content of the document, content type, location information, user device information, etc.

At 406, a determination is also made as to whether the content selection server or the content item server may provide content items related to an online campaign, e.g., an experiment. The experiment is described in FIG. 3. In some implementations, the server detects if an experiment is running, where the experiment is the evaluation of the online campaign's effectiveness based on offline activity.

The third party content provider, such as an advertiser, may want to provide content items to a client device using the experiment, wherein the content items may be correlated to offline activity. The third party content provider may set the parameters for the experiment, such as a specific geographic area, time, etc. for the experiment In some implementations, the content provider may select a percentage of content items from the online campaign to be served. The content provider may opt out of the experiment and provide content items based on other criteria.

At 408, if the content provider has selected the experiment, then the content selection server provides the appropriate content item based on the criteria of the experiment. The content selection server may select a content item based on the content item performance, such as quality score, relevance, etc., the location of the user, etc. In this implementation, the content item may include content identifier data that identifies the content item from the online campaign. The content item may include code for prompting the client device to send the identifier data to the mobile computing device, such as a tone, set of tones, symbol such as an OR code, wireless data signal, etc.

In other implementations, if the content provider has not selected the experiment, then the content selection server may provide a content item based on criteria other than the experiment, which is served to the mobile computing device. The content selection server may filter any content items that are not relevant to the content, the user, etc.

At 410, the content item server provides the content item related to the experiment to the client device. Data related to the served content item may be stored at the server or other appropriate component. At 412, the user is exposed to the content item. Based on the exposure to the content item, the client device provides (outputs) a signal at 414.

In some implementations, the content selection server may determine content items related to a number of online campaigns. In other implementations, the content selection server may serve a number of different content items from the online campaign. In another implementation, the content item server may serve the same content item, but updated with dynamic elements, such as text, graphics, etc. In other implementations, the content item provided to the user may be a control content item. For example, the content provider may want to determine how the content item within the online campaign performs in terms of clicks, conversions, etc. compared to the control content item.

Example 400 may provide the user with an increased sense of the product/brand associated with the content item. For example, the user may have performed an online search for the product, such as product specifications, reviews, pricing, etc. In some implementations, however, the user may make purchases offline, such as at a retail store location. The offline purchase may be influenced by the online content item that is provided to the user. It may be useful to a content provider to determine the correlation between the content item provided to the user and the offline purchase.

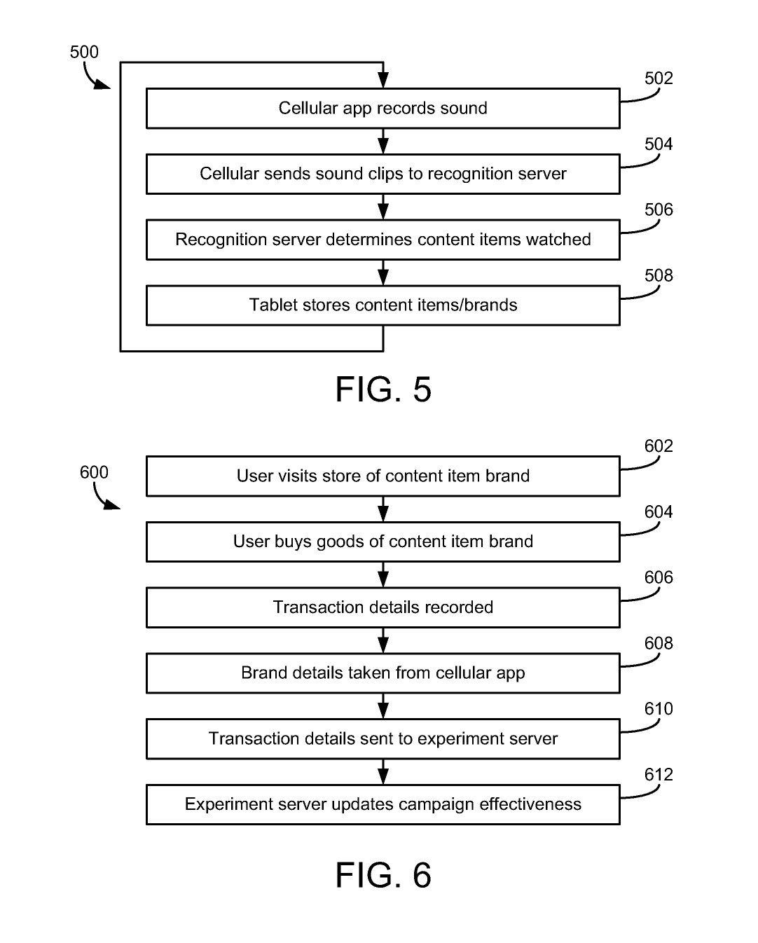

FIG. 5 is an example 500 of a flow diagram of a mobile device that periodically updates a signal that is stored, in accordance with a described implementation.

At 502, the user's mobile device stores a signal that has been provided by the client computer, such as a desktop, laptop or tablet, to the mobile computing device. The signal may be provided to a web browser or another application on the client computer. The user may view a content item on the client computer, which triggers the signal to be transmitted to the user's mobile computing device. As shown in FIG. 5, the signal may be recorded as a sound signal on an application of the mobile computing device. The signal may be stored in a memory on the mobile device.

At 504, the user's mobile computing device may transmit the signal to a recognition server. For example, the mobile computing device may transmit the sound signal (e.g., sound clips) to a recognition server. The recognition server may be configured to detect the signal from the mobile computing device.

At 506, the recognition server may determine which content items were viewed by the user at the client computer. At 508, the client computer, such as a tablet, may store the content item(s) and/or brand(s) that were viewed by the user.

FIG. 6 is an example 600 of a flow diagram of a user engaging in offline activity, in accordance with a described implementation.

At 602, a user may visit a retail location that sells a product described by the content item. In some implementations, the retail location may be associated with a content item. In some implementations, the association may be determined from a user visiting the retail location, after viewing the content item that was provided to the user online. The association between the point of interest and the content item may be stored in a repository along with the online campaign data.

At 604, the user may purchase a product at the point of interest that is associated with the online content item served to the user. At 606, the details of this transaction may be recorded and stored by the user's mobile computing device that was used during the transaction. For example, the activity at the point of interest may be linked to a user identifier in order to determine the correlation between the product purchased and the online content item served to the user.

At 608, the content item information, such as brand details, is received by the experiment server from the user's mobile computing device, e.g., from a mobile application. At 610, content item information and transaction information is provided by the user's mobile computing device to the experiment server. The transaction information may include offline activity of a user representing a purchase made by the user at a physical location in a geographic region, such as a store in a particular city. For example, the transaction information may include data indicating that the user made a purchase from a merchant, such as time of day, amount of purchase, related items to the purchase, etc. The mobile computing device provides the information about the transaction to the experiment server. The third party content provider may select the offline activity to be included within any performance determination of the online campaign.

At 612, the effectiveness and other performance metrics of the online campaign may be updated based on the transaction information. Statistical and performance metrics related to the online campaign may be generated, using the transaction information from the mobile computing device, by the experiment server. The third party content provider may use the generated information to select parameters for a subsequent online campaign.

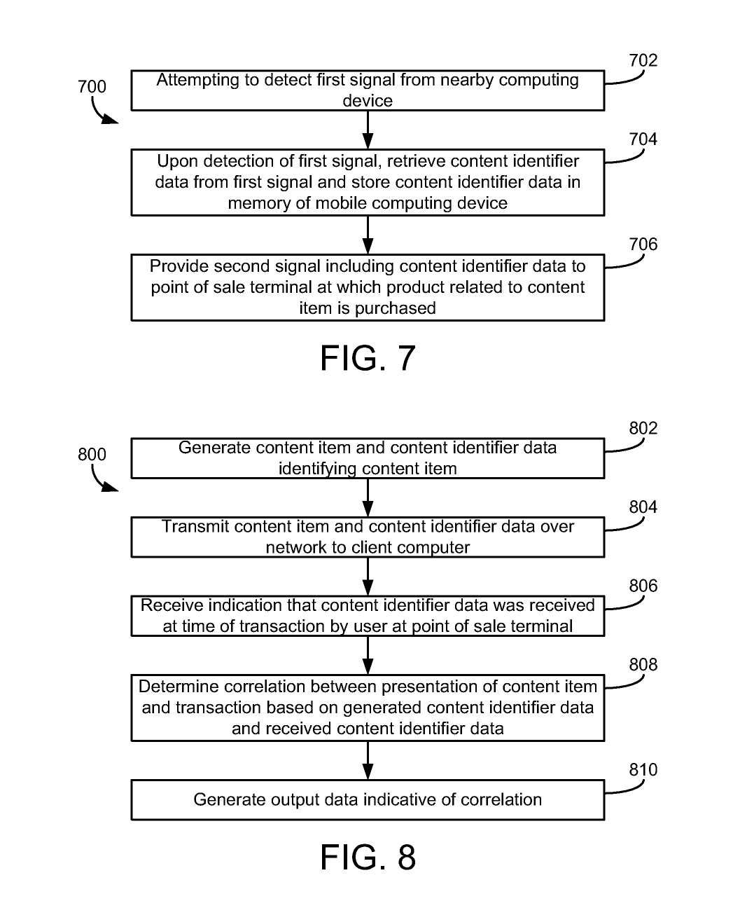

FIG. 7 is an example of a flow chart of a method 700 for providing a signal to a point of sale terminal in accordance with a described implementation. Example method 700 may be implemented by various combinations of systems. Example method 700 may be performed online or offline.

At block 702, a mobile computing device may monitor or scan to detect a first signal from a nearby computing device. The monitoring or scanning may be done automatically, without requiring user input or user activation of any component of the device. For example, a Wi-Fi receiver on the mobile device may be continuously monitoring for Wi-Fi signals sent from the nearby computing device. Upon detecting a Wi-Fi signal, the mobile computing device may be configured to receive a content identifier . . . . Alternatively, the mobile device may be configured to be activated by a user and then held near a display of the nearby computing device and configured to read a visual code from a display screen. Alternatively, the mobile device may be configured to monitor or scan continuously for an audio sound to be emitted by the nearby computing device, the audio sound modulated with a code unique to the content item being displayed at the time the sound is emitted. The first signal may include content identifier data. The content identifier data may identify a content item from an online campaign displayed on the computing device. The first signal may include a visual signal, a sound signal, a wireless data signal, etc.

The online campaign may be conducted by providing a content item to a user in a geographic region for an interval of time. The content item may be associated with a brand name of a product. The content item may be directly (or indirectly) entered, maintained, tracked, etc. by one or more content sources, such as content providers. The content item may be stored in the content selection server, a database, a memory, etc. The content item may be graphical, textual, images, audio, video, a combination of these formats, or any other type of electronic content item. The content item may also include embedded information, such as links, metadata, machine-executable instructions (HTML, JavaScript, etc.), etc.

The method may also include receiving data indicative of online activities of a user associated with the online campaign. The data may be received by the content selection server. The online activities of the user may include activities defined by the content provider. Online activities may also include viewing the content item, interacting with the content item, clicking the content item, performing a search using keywords related to the content provider's products, visiting a content provider's resource, visiting resources associated with the content provider such as a review or a product comparison resource, etc.

At block 704, upon detection of the first signal, the content identifier data may be retrieved from the first signal. The content identifier data may be stored in a memory of the mobile computing device.

At block 706, the mobile computing device may provide a second signal to a point of sale terminal at which a product related to the content item is purchased. The second signal may include the content identifier data. The second signal may be stored by the mobile computing device. The second signal may be provided by the mobile device and received at the point of sale terminal using any of a number of different technologies, such as Near Field Communications devices, Wi-Fi transceivers, an infrared transmitter/receiver pair, Bluetooth or Zigbee communication devices, bar code scanning, etc. Upon receiving the second signal, the point of sale terminal is configured to retrieve the content identifier data from the signal and transmit the content identifier data over the Internet to the content selection server or other server configured to run the experiment.

FIG. 8 is an example of a flow chart of a method 800 for determining a correlation between presentation of a content item and a transaction by a user at a point of sale terminal in accordance with a described implementation. Example method 800 may be implemented by various combinations of systems. Example method 800 may be performed online or offline.

At block 802, a content item and content identifier data identifying the content item are generated by a server computer. In some implementations, a request for the content item is received. In some implementations, the content item may be selected from a plurality of content items. The selection of the content item may be based on a content item auction. In some implementations, the content item may include an advertisement.

At block 804, the content item and the content identifier data may be transmitted over a network to a client computer. The content item or the content identifier data may be configured to cause the client computer to display the content item on a display screen showing a web page and to emit a signal based on the content identifier data in the form of at least one of a visual signal, a sound signal or a wireless data signal.

At block 806, an indication is received at a server computer that the content identifier data was received at the time of a transaction by a user at a point of sale terminal.

At block 808, a correlation between presentation of the content item and the transaction based on the generated content identifier data and the received content identifier data is determined. The correlation may measure variables at two different points to determine if the variables are related. The correlation may include a temporal correlation or a spatial correlation. For example, the correlation may be between the online activity and the offline activity as a function of spatial distance or temporal distance between the two points. The temporal distance may be measured by time whereas the spatial distance may be measured by units such as length, width, height, etc. The determination may be made by the server computer. The determination may be a statistical computation. For example, the determination of the correlation may be made by constructing a Monte Carlo model of the correlation. In another example, the determination of the correlation may be made by computing a cross correlation between the presentation of the content item and the transaction based on the generated content identifier data and the received content identifier data.

At block 810, output data indicative of an effect of the online campaign based on the correlation is generated. The output data may be used by the content provider to select keywords for the online campaign. The output data may be a report that indicates the effectiveness of the online campaign. The effectiveness of the online campaign is further enhanced by the correlation. The content provider may use the output data to improve optimization and budget decisions for providing content items. The optimization may be performed on at least one parameter of the online campaign, e.g., the selection criteria.

Implementations of the subject matter and the functional operations described in this specification may be implemented in other types of digital electronic circuitry, or in computer software embodied on a tangible media, firmware, or hardware, including the structures disclosed in this specification and their structural equivalents, or in combinations of one or more of them.

Implementations of the subject matter and the operations described in this specification may be implemented in digital electronic circuitry, or in computer software embodied on a tangible medium, firmware, or hardware, including the structures disclosed in this specification and their structural equivalents, or in combinations of one or more of them. The subject matter described in this specification may be implemented as one or more computer programs, e.g., one or more modules of computer program instructions, encoded on one or more computer storage media for execution by, or to control the operation of, data processing apparatus. Alternatively or in addition, the program instructions may be encoded on an artificially-generated propagated signal, e.g., a machine-generated electrical, optical, or electromagnetic signal that is generated to encode information for transmission to suitable receiver apparatus for execution by a data processing apparatus. A computer storage medium may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially-generated propagated signal. The computer storage medium may also be, or be included in, one or more separate components or media (e.g., multiple CDs, disks, or other storage devices). Accordingly, the computer storage medium is tangible.

The operations described in this specification may be performed by a data processing apparatus on data stored on one or more computer-readable storage devices or received from other sources.

The term “data processing apparatus” or “computing device” encompasses all kinds of apparatus, devices, and machines for processing data, including by way of example a programmable processor, a computer, a system on a chip, or multiple ones, or combinations of the foregoing The apparatus may include special purpose logic circuitry, e.g., an FPGA (field programmable gate array) or an ASIC (application-specific integrated circuit). The apparatus may also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment may realize various different computing model infrastructures, such as web services, distributed computing and grid computing infrastructures.

A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer may be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations of the subject matter described in this specification may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

While this specification contains many specific implementation details, these should not be construed as limitations on the scope of any inventions or of what may be claimed, but rather as descriptions of features specific to particular implementations of particular inventions. Certain features described in this specification in the context of separate implementations may also be implemented in combination in a single implementation. Conversely, various features described in the context of a single implementation may also be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated in a single software product embodied on a tangible medium or packaged into multiple software products embodied on tangible media.

Thus, particular implementations of the subject matter have been described. Other implementations are within the scope of the following claims. In some cases, the actions recited in the claims may be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
attempting, by a mobile computing device, to detect a first signal from a nearby computing device, the first signal comprising content identifier data which identifies a content item from an online campaign displayed on the computing device, the first signal comprising at least one of a visual signal, a sound signal, or a wireless data signal;
upon detection of the first signal, retrieving the content identifier data from the first signal and storing the content identifier data in a memory of the mobile computing device; and
providing, by the mobile computing device, a second signal comprising the content identifier data to a point of sale terminal at which a product related to the content item is purchased.

2. The computer-implemented method of claim 1, wherein the online campaign is directed toward a geographic region for an interval of time.

3. The computer-implemented method of claim 1, further comprising:
providing, by the mobile computing device, a request for the content item.

4. The computer-implemented method of claim 3, further comprising:
selecting the content item from a plurality of content items associated with the online campaign for display on the mobile computing device.

5. The computer-implemented method of claim 4, wherein the selection of the content item is based on a content item auction.

6. The method of claim 1, further comprising:
storing, by the mobile computing device, the second signal.

7. A computer-implemented method, comprising:
generating, at a server computer, a content item and content identifier data identifying the content item;
transmitting the content item and content identifier data over a network to a client computer, wherein the content item or content identifier data is configured to cause the client computer to display the content item on a web page and to emit a signal based on the content identifier data in the form of at least one of a visual signal, a sound signal, or a wireless data signal;
receiving, at the server computer, an indication that the content identifier data was received at the time of a transaction by a user at a point of sale terminal;
determining a correlation between presentation of the content item and the transaction based on the generated content identifier data and the received content identifier data; and
generating output data indicative of the correlation.

8. The computer-implemented method of claim 7, further comprising:
selecting the content item from a plurality of content items.

9. The computer-implemented method of claim 8, wherein the selection of the content item is based on a content item auction.

10. The computer-implemented method of claim 7, receiving a request for the content item.

11. The computer-implemented method of claim 7, wherein the content item comprises an advertisement.

12. The computer-implemented method of claim 7, wherein the determination of the correlation comprises constructing a Monte Carlo model of the data.

13. The computer-implemented method of claim 7, wherein the determination of the correlation comprises computing a cross correlation between presentation of the content item and the transaction based on the generated content identifier data and the received content identifier data.

14. The computer-implemented method of claim 7, wherein the output data is used to perform optimization of an online campaign.

15. The computer-implemented method of claim 14, wherein the optimization is performed on at least one parameter of the online campaign.

16. The computer-implemented method of claim 15, wherein the optimization is performed on selection criteria of the online campaign.

17. A computer-readable storage medium having instructions therein, the instructions being executable by a processor to cause the processor to perform operations comprising:
generating, at a server computer, a content item and content identifier data identifying the content item;
transmitting the content item and content identifier data over a network to a client computer, wherein the content item or content identifier data is configured to cause the client computer to display the content item on a resource and to emit a first signal based on the content identifier data in the form of at least one of a visual signal, a sound signal, or a wireless data signal;
receiving, at the server computer, an indication that the content identifier data was received at the time of a transaction by a user at a point of sale terminal;
determining a correlation between presentation of the content item and the transaction based on the generated content identifier data and the received content identifier data; and
generating output data indicative of the correlation.

18. The computer-readable storage medium of claim 17, wherein the determination of the correlation comprises constructing a Monte Carlo model of the data.

19. The computer-readable storage medium of claim 17, wherein the determination of the correlation comprises computing a cross correlation between presentation of the content item and the transaction based on the generated content identifier data and the received content identifier data.

20. The computer-readable storage medium of claim 17, wherein the output data is used to perform optimization of an online campaign.
